(19) United States
(12) Patent Application Publication
(10) Pub. No.: US 2002/0147836 A1
(43) Pub. Date: Oct. 10, 2002

(54) Routing notifications to mobile devices

(75) Inventor: Stephen D. Flanagin, Sammamish, WA (US)

Correspondence Address: WORKMAN NYDEGGER & SEELEY, 1000 EAGLE GATE TOWER, 60 EAST SOUTH TEMPLE, SALT LAKE CITY, UT, 84111, US

(73) Assignee: Microsoft Corporation

(21) Appl. No.: 09/774,407

(22) Filed: Jan. 31, 2001

(51) Int. Cl. G06F 15/173

(52) U.S. Cl. 709/238

(57) ABSTRACT

Systems, methods and computer program products for routing notifications to wireless devices. Notifications are routed over a high capacity channel instead of a low capacity channel when the wireless device has access to the high capacity channel. The wireless device notifies a notification server when the wireless device has access to a high capacity channel and notifications are routed over the high capacity channel. When access to the high capacity channel is lost, the notification server resumes transmitting the notifications over the low capacity channel.

### BACKGROUND OF THE INVENTION

1. The Field of the Invention

The present invention relates to notifications for wireless devices. More particularly, the present invention relates to systems, methods, and computer program products for routing notifications to wireless devices over high capacity channels and more specifically for re-routing notifications to wireless devices over high capacity channels when they are available to the wireless device.

2. Background and Related Art

Wireless devices, such as cellular telephones, pagers, and personal digital assistants (PDAs) are quite common and their use and importance are increasing daily. For example, cellular telephones were originally intended for voice communication. Today, cellular telephones are being used to receive and store electronic messages, calendar data, and contact lists. Some wireless devices even allow a user to access the Internet in limited ways. The ever increasing capabilities of wireless devices are placing a strict demand on the systems that deliver information to wireless devices. Unfortunately, current delivery systems are often unable to satisfactorily meet the delivery requirements of newer wireless devices.

Much of the information currently stored by wireless devices, such as electronic messages and appointments, has a tendency to become stale, old, or no longer needed. As a result, it is often necessary to update the stored data. An update is necessary, for example, when a new electronic message arrives or when new appointments are added to the calendar data.

Historically, devices are updated by connecting with a server and performing a ‘batch’ synchronization to update both the device and the server. Batch synchronization updates all changes since the last synchronization and is usually performed over a dial-up connection or Local Area Network connections that have attributes of higher throughput, reliability and low cost. As an alternative, each individual change can be sent to the device (or from the device to the server) when the change occurs. This approach has the advantage of being automatic. In addition, the data stored on the device is substantially current. This approach, however, requires that these updates or ‘notifications’ be delivered to the device asynchronously, wherever the device may be located.

Currently, delivering data to and from wireless devices uses short messaging system (SMS) or related technologies. SMS was originally designed for devices such as pagers, where the electronic traffic is limited to short textual messages. SMS has a relatively low capacity to transmit data, can be costly, and can have high latency. SMS is often used to send a short message to another wireless device, receive a notification from a network that a voicemail has been stored, and the like. While SMS is ill suited to support systems and methods that generate substantially higher data traffic, it does have the desirable characteristics of having fairly global coverage already in place and is usually available for small information transfers at a nominal cost.

### SUMMARY OF THE INVENTION

These and other problems are overcome by the present invention, which is directed towards routing notifications over higher capacity channels when the higher capacity channels are available. When data at a server changes, a notification is sent to a wireless device. The notification can either notify the wireless device that an object at the server has changed or include the changed object in the notification. For example, when a new email arrives at a server, the notification can either inform the wireless device that a new email is at the server or the notification can include the new email. As previously described, the notification usually occurs over a low capacity wireless channel that is often slow, costly and inherently latent.

The present invention effectively causes notifications to be routed over higher capacity and less costly channels when the higher capacity channels are available to the wireless devices instead of using the more costly lower capacity channel. For example, many wireless devices have the ability to dock or connect with a desktop computer or other network device when the user is in their office or home. Many desktop computers have access to a Local Area Network (LAN) or the Internet, and when a wireless device is docked or in communication with the desktop computer or its LAN, the wireless device advises the notification server that a higher capacity channel is available through the desktop computer and its network connection. When the notification server is aware that the wireless device has access to a higher capacity channel, notifications are routed to the wireless device over the higher capacity channel. As long as the wireless device has access to the higher capacity channel, notifications can be sent quickly, inexpensively, and more efficiently.

Access to the higher capacity channel, however, can be terminated abruptly Removing the wireless device from its docking station, for example, may immediately cut off access to the higher capacity channel. When the wireless device no longer has access to the higher capacity channel, the notification server resumes sending notifications over the lower capacity SMS wireless channel as before.

Detecting that the higher capacity channel is no longer available can be performed in several different ways. While docked, for example, the wireless device can be required to send an acknowledgement to the notification server for each notification that the wireless device receives. If an acknowledgement is not received by the notification server within a pre-determined time period, the notification server resumes sending notifications over the lower capacity channel. Alternatively, the characteristics of the higher capacity channel can be used to determine if the higher capacity channel is still available. For instance, if Transmission Control Protocol/Internet Protocol (TCP/IP) is used, then the severance of the higher capacity channel is detected when the socket is dropped. In another example, the wireless device can send a notification to the server that the connection has been severed. In each case, notifications are again sent over the low capacity channel until a higher capacity channel becomes available.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary system that provides a suitable operating environment for the present invention;

FIG. 2 is a block diagram illustrating a server that communicates with a wireless device over a high capacity channel when the high capacity channel is available and over a low capacity channel otherwise; and

FIG. 3 is a more detailed block diagram of the communication channels over which a server may communicate with a wireless device.

### DETAILED DESCRIPTION OF THE INVENTION

Communication with a wireless device can be a costly and relatively slow process. The present invention relates to systems and methods that allow communication with a wireless device to occur over channels that have higher capacity than the default low capacity channel when the higher capacity channels are available. When a higher capacity channel is available, a notification server reroutes notifications to a wireless device over the higher capacity channel. The notification server resumes employing the low capacity channel when the higher capacity channel is no longer available This provides significant advantages. First, the higher capacity channel has a much lower cost in comparison to the low capacity channels currently employed by wireless devices. The higher capacity channel also provides more bandwidth and is more reliable. Because the higher capacity channel is not always available to the wireless device, the lower capacity channel is frequently used to ensure continuous update capability to the wireless device.

As used herein “notification” refers to communication with a wireless device and can refer to both incoming and outgoing communications. Notifications typically occur when an object is created or modified. Thus, when an object on a server changes, the wireless device receives a notification. The notification can simply inform the wireless device that an object has been created, modified, or otherwise changed or the notification can include the created or modified object. A notification is usually associated with a single data object, but as used herein, notification may be associated with more than one data object.

As used herein “high capacity channels” infers higher bandwidth with respect to “low capacity channels.” However, high capacity channel can also refer to one or more of higher capacity, less cost, increased reliability, and less latency with respect to low capacity channel.

The present invention extends to both systems and methods for routing notifications to wireless devices. The embodiments of the present invention may comprise a special purpose or general purpose computer including various computer hardware, as discussed in greater detail below. Embodiments within the scope of the present invention also include computer-readable media for carrying or having computer-executable instructions or data structures stored thereon. Such computer-readable media can be any available media which can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

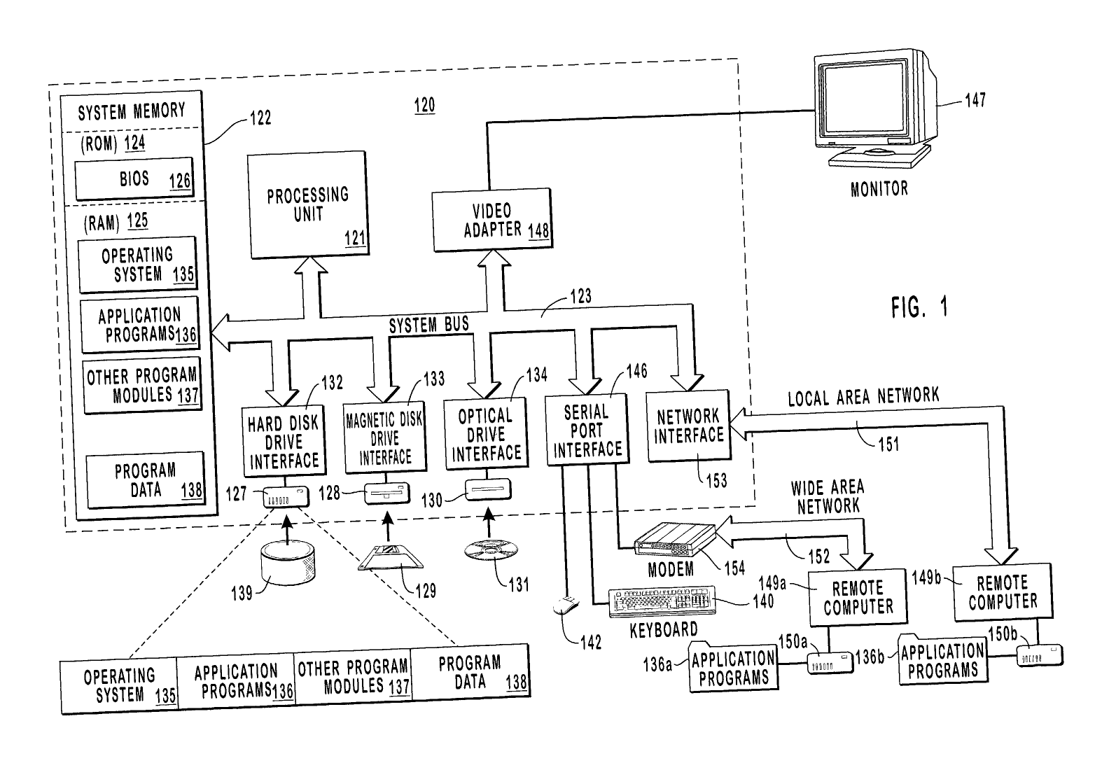

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, cellular telephones, pagers, personal digital assistants, network or desktop PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices. Those skilled in the art will also appreciate that some computer system configurations, such as cellular telephones, pagers, and the like are not required to have each component illustrated in FIG. 1 in order to qualify as a computer environment in which the present invention may be implemented. For this reason, many devices, including but not limited to, cellular telephones, PDAs, pagers and the like, qualify as a computer as described herein. In addition, a computer as described herein is not limited to the components illustrated in FIG. 1.

With reference to FIG. 1, an exemplary system for implementing the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24.

The computer 20 may also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules and other data for the computer 20. Although the exemplary environment described herein employs a magnetic hard disk 39, a removable magnetic disk 29 and a removable optical disk 31, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 39, magnetic disk 29, optical disk 31, ROM 24 or RAM 25, including an operating system 35, one or more application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port or a universal serial bus (USB). A monitor 47 or another display device is also connected to system bus 23 via an interface, such as video adapter 48. In addition to the monitor, personal computers typically include other peripheral output devices (not shown), such as speakers and printers.

The computer 20 may operate in a networked environment using logical connections to one or more remote computers, such as remote computers 49a and 49b. Remote computers 49a and 49b may each be another personal computer, a server, a router, a network PC, a peer device or other common network node, and typically include many or all of the elements described above relative to the computer 20, although only memory storage devices 50a and 50b and their associated application programs 36a and 36b have been illustrated in FIG. 1. The logical connections depicted in FIG. I include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

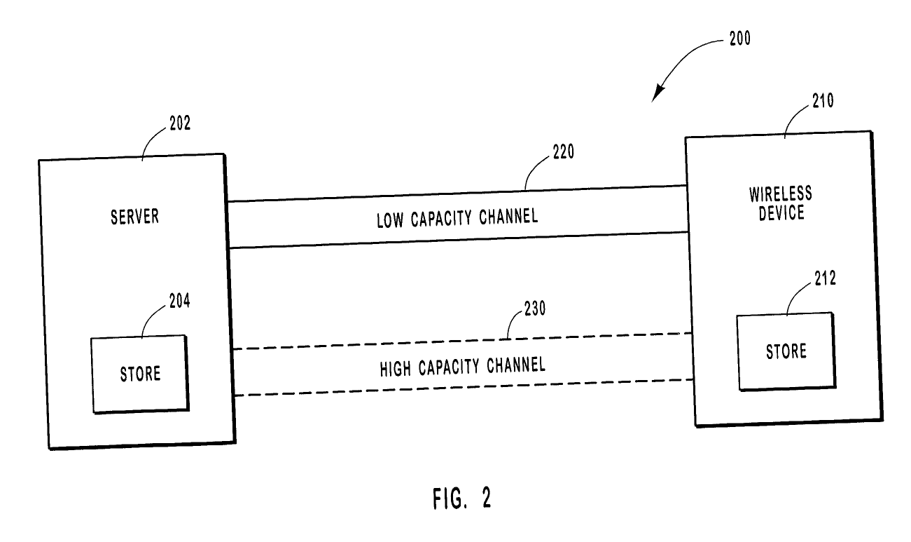

FIG. 2 is a block diagram that generally illustrates an environment wherein the present invention may be implemented. FIG. 2 illustrates a system 200 that includes a server 202 and a wireless device 210. Exemplary wireless devices include, but are not limited to, cellular telephones, pagers, personal digital assistants (PDAs), Web TVs, Internet appliances, and the like. The server 202 has a store 204 and the wireless device 210 has a store 212. The store 204 typically has significantly more storage capacity than the store 212 and the store 204 is often used by multiple wireless devices as well as other computers. The server 202 is often part of a local area network (LAN). However, FIG. 2 is intended to represent an instance where the server 202 is accessed by a wireless device. It is understood that the server 202 can be part of many other computer networks or other system configurations.

Often, it is necessary for the server 202 to communicate with or send a notification to the wireless device 210. This can occur, for example, when a new electronic message arrives at the server 202, or more generally, when an object stored at the server 202 changes. Changes to objects include, but are not limited to, deleting an object, creating an object, moving an object, modifying an object, and the like. When a change to an object occurs, a notification is generated at the server 202 and transmitted to the wireless device 212. As previously stated, the notification can simply advise the wireless device 210 of the change to the object or the notification can actually contain the changed object. In the case of email, for example, the notification can inform the wireless device 210 that a new mail message is stored at the server 202 or the notification can include the new mail message. In the first instance, a user of the wireless device 210 is required to retrieve the new mail message. It is understood by one of skill in the art that the notification sent to the wireless device 210 is not limited to email, but can include any data, including but not limited to, calendar data, documents, and the like.

In order to keep the device continuously up to date, notifications are sent to the wireless device 210 over a channel that is always available. A wireless Short Messaging Service (SMS) or like technology channel is typically used because it can usually deliver a notification message even though it has a lower transmission capacity. SMS describes the ability to send and receive small text messages (on the order of 160 characters) to the wireless device 210. SMS, or more generally, the low capacity channel 220, is not conducive to sending or receiving long messages. In addition to being restricted to short messages, SMS and similar wireless protocols can incur additional cost to the user, especially if it is used to send large messages.

FIG. 2 also illustrates a high capacity channel 230 that provides for communication between the server 202 and the wireless device 210. While the high capacity channel 230 overcomes the limitations of the low capacity channel 220, the high capacity channel 230 is not always available for use in the system 200. However, notifications are sent over the high capacity channel 230 instead of the low capacity channel 220 whenever the high capacity channel 230 is available to the wireless device 210. This enables more data to be sent more quickly and more efficiently with less cost. Full synchronization between the wireless device 210 and the server 202 can also occur more efficiently over the high capacity channel 230. In addition, the cost of using the high capacity channel 230 is often significantly lower than the cost associated with the low capacity channel 220.

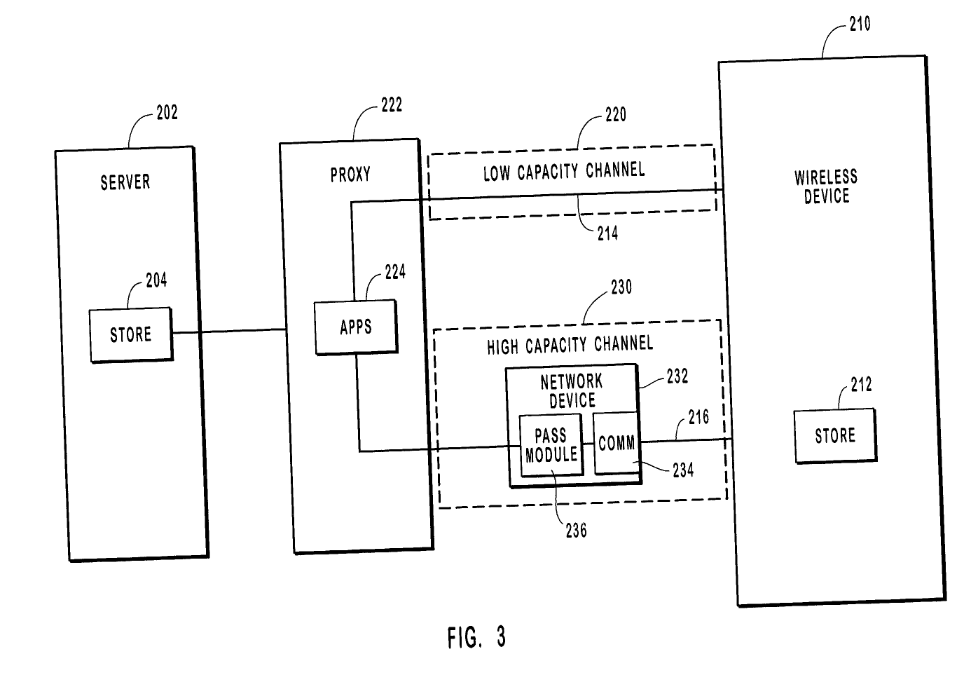

FIG. 3 is a block diagram that more fully illustrates a wireless device that communicates with a server over a high capacity channel 230 or a low capacity channel 220. The low capacity channel 220 often includes a proxy 222 as an intermediary between the wireless device 210 and the server 202. The communication link 206 can be the Internet, a Local Area Network (LAN), and the like, but can also include wireless networks.

The proxy 222 communicates with the wireless device 210 over a wireless communication link 214 that is often provided by a wireless carrier. The communication link 214 often employs Short Messaging Service (SMS) or related technologies, which generally describe the ability to send small text messages over a wireless communication link. Because of the nature of wireless communications, there is no guarantee that message sent using SMS will actually arrive at the wireless device 210, but the nature of SMS coverage and buffering usually ensures the small SMS message will be delivered to the device in a timely manner. While SMS is useful in some circumstances, it is significantly less useful when the update is substantially larger than messages typically sent with SMS. These types of updates, for example, occur when the wireless device 210 and the server 202 synchronize the stores 204 and 212. Larger updates can also occur when sending calendar data or electronic messages that are longer than the messages permitted by SMS.

The proxy 222 includes applications (apps) 224 that assist in the process of sending a notification to the wireless device 210. The applications 224 include a format module and a wireless channel module. The format module formats the notification for the intended client device, which is the wireless device 210 in this case. The wireless channel module processes the notification such that the notification is compatible with the transmission channel, which may be, for example, SMS.

FIG. 3 also illustrates a network device 232. The network device 232 is capable of communicating with the proxy 222 over the Internet, a LAN, and the like. The network device 232 becomes part of the high capacity channel 230 when the wireless device 210 is capable of communication with the network device 232. For example, the wireless device 210 may be a personal digital assistant (PDA), a cellular telephone or other wireless device that is capable of docking or otherwise connecting with a network device such as a desktop computer. When the PDA is docked or otherwise connected with the desktop computer, the PDA has access to the desktop computer over a communication link 216 through communication port 234, which may be a serial port, a universal serial bus port, an infrared port, Bluetooth Personal Area Wireless connection, and the like. The communication link 216 has higher bandwidth than the communication link 214 and is significantly faster and less expensive.

When the wireless device 210 is docked with the network device 232, the wireless device 210 notifies the proxy 222 that notifications or updates can be sent through the network device 232 instead of over the communication link 214. This has the advantages of lower cost and significantly higher bandwidth. The wireless device 210 notifies the proxy 222 that it can use the new high capacity channel 230 and the proxy 222 is provided with a return address where notifications and updates can now be sent. In this case, the proxy 222 is provided with the address of the network device 232 or the pass module 236. In the proxy 222, a network channel module, which is included in the applications 224, formats the updates or the notifications for the higher capacity channel or communication link, which may be an Ethernet connection, the Internet, and the like. A pass module 236 passes the notifications or updates received from the proxy 222 through the network device 232 to the wireless device 210 over the communication link 216.

When the wireless device 210 has access to high speed networks through the network device 232, the proxy 222 and the server 202 are effectively notified of this fact through the network device 232. At this point, the proxy 222 re-routes or directs the notifications and updates over the high capacity channel 230. From the perspective of the server 202, notifications and updates are still sent to the proxy 222. In this manner, the notifications and updates are rerouted through the network device 232 instead of over the wireless communication link 214.

Because the proxy 222 is re-routing or re-directing the notifications, the proxy 222 is usually responsible for detecting when the high capacity channel is no longer available to the wireless device 210 with respect to notifications and updates. The connection between the wireless device 210 and the network device 232 can terminate abruptly. For example, a PDA or wireless phone can simply be removed from a docking cradle. Detecting when the link is severed can be accomplished in several ways. The wireless device 210, for instance, may be required to send an acknowledgement to the proxy 222 for each notification that is received over the high capacity channel 230. If no acknowledgement is received, the proxy 222 can assume that the connection has been severed and the proxy 222 will resume sending notifications using the low capacity channel 220. In some instances, the acknowledgement should be received within a particular time period. If TCP/IP is used, then the severance of the communication link will be detected when the socket is dropped or lost. Alternatively, the wireless device 210 can detect when the connection is lost and notify the proxy 222 over the low capacity channel 220 that further notifications should be sent over the low capacity channel 220.

While the present invention has been described with the proxy 222 being an integral part of both the low capacity channel 220 and the high capacity channel 230, it is understood that the proxy 222 could be bypassed in some circumstances when the high capacity channel 230 is available As described, however, the server 202 is often unaware of which channel is used to transmit the notifications and updates to the wireless device 210. In another embodiment, the network device may have direct access to the server 202 and will, as a result, perform the systems and methods described herein directly with the server 202 instead of through the proxy 222.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. In a system including a wireless device and a notification server, wherein the notification server sends notifications to the wireless device over a low capacity channel, a method for routing the notifications over a high capacity channel whenever a high capacity channel is available to the wireless device, the method comprising the wireless device performing:
an act of detecting the high capacity channel;
an act of notifying the notification server that the wireless device has access to the high capacity channel;
an act of receiving the notifications from the notification server over the high capacity channel.

2. A method as defined in claim 1, wherein the act of detecting the high capacity channel further comprises as act of connecting the wireless device with a network device, wherein the wireless device communicates with the network device over a communication link, wherein the act of connecting the wireless device can occur automatically.

3. A method as defined in claim 2, wherein the network device is one of a desktop computer, a blue tooth enabled LAN, and a kiosk.

4. A method as defined in claim 2, wherein the communication link is one of a serial link, a universal serial bus link, a wireless Bluetooth link and an infrared link.

5. A method as defined in claim 1, wherein the act of detecting the high capacity channel further comprises an act of communicating with a network device over a communication link.

6. A method as defined in claim 1, wherein the act of notifying the notification server comprises an act of sending an access notification to the notification server, wherein the access notification identifies that the high capacity channel is available for notifications sent to the wireless device.

7. A method as defined in claim 1, wherein the act of notifying the notification server further comprises an act of providing the notification server with a new address, wherein the notifications are routed to the new address.

8. A method as defined in claim 1, further comprising an act of detecting that the wireless device no longer has access to the high capacity channel.

9. A method as defined in claim 8, wherein the act of detecting that the wireless device no longer has access to the high capacity channel further comprises an act of sending an acknowledgement to the notification server for each notification received by the wireless device.

10. A method as defined in claim 8, wherein the act of detecting that the wireless device no longer has access further comprises the act of notifying the notification server over the low capacity channel that notifications can no longer be sent over the high capacity channel.

11. A computer program product having computer executable instructions for performing the acts recited in claim 1.

12. In a system including a wireless device and a notification server, wherein the wireless device and the notification server communicate over a low capacity channel, a method for the wireless device and the notification server to communicate over a high capacity channel, the method comprising steps for:
accessing the high capacity channel by the wireless device;
establishing communication over the high capacity channel between the wireless device and the notification server;
sending notifications over the high capacity channel instead of the low capacity channel; and
when access to the high capacity channel terminates, resume sending notifications over the low capacity channel.

13. A method as defined in claim 12, wherein the step for accessing the high capacity channel further comprises:
an act for connecting the wireless device with a network device, wherein the network device has an existing access to the high capacity channel; and
an act of detecting the high capacity channel by the wireless device.

14. A method as defined in claim 12, wherein the act of establishing communication over the high capacity channel further comprises:
an act of notifying the notification server, by the wireless device, that the wireless device has access to the high capacity channel;
an act of providing the notification server with an address such that the wireless device receives the notifications over the high capacity channel; and
an act of formatting the notifications for transmission over the high capacity channel.

15. A method as defined in claim 12, further comprising a step for determining that the wireless device can no longer receive notifications over the high capacity channel.

16. A method as defined in claim 15, wherein the step for determining that the wireless device can no longer receive notifications over the high capacity channel comprises:
an act of sending an acknowledgement by the wireless device for each notification sent by the notification server; and
an act of determining that the wireless device no longer has access to the high capacity channel if the notification server does not receive a particular acknowledgement for a particular notification within a predetermined time period.

17. A method as defined in claim 12, further comprising a step for resuming the step for sending notifications over the high capacity channel when the wireless device again has access to the high capacity channel.

18. A method as defined in claim 12, further comprising a step for preparing the notification for transmission over the high capacity channel when the wireless device has access to the high capacity channel.

19. A method as defined in claim 12, further comprising a step for preparing the notification for transmission over the low capacity channel when the wireless device does not have access to the high capacity channel.

20. A computer program product having computer executable instructions for performing the steps recited in claim 12.

21. In a system including a wireless device and a server, wherein the wireless device receives updates from the server over a first channel through a proxy server, a method for receiving the updates at the wireless device over a second channel, the second channel having higher capacity than the first channel, the method comprising:
an act of providing the wireless device with access to the second channel through a network device when the wireless device is in communication with the network device;
an act of contacting the proxy server over the second channel to notify the proxy server that the wireless device has access to the second channel; and
an act of receiving notifications from the server over the second channel until the wireless device no longer has access to the second channel, wherein the notification are re-routed by the proxy server over the second channel.

22. A method as defined in claim 21, further comprising an act of receiving notifications over the first channel when the second channel is not available to the wireless device.

23. A method as defined in claim 21, wherein the act of providing the wireless device with access to the second channel further comprises an act of connecting the wireless device at a docking station, the docking station having a communication link with the network device that provides the wireless device has access to the second channel through the network device.

24. A method as defined in claim 21, further comprising an act of sending notifications over the first channel when the wireless devices loses access to the second channel.

25. In a system including a wireless device and a notification server, wherein the notification server sends a notification to the wireless device through a proxy server over a low capacity channel, a method for routing the notification over a high capacity channel when the high capacity channel is available, the method comprising:
an act of detecting that the wireless device has access to the high capacity channel;
an act of the proxy server receiving an access notification from the wireless device, wherein the access notification informs the proxy server that the wireless device has access to the high capacity channel;
an act of the proxy server routing the notification to the wireless device over the high capacity channel instead of the low capacity channel; and
an act of the proxy server resuming sending the notification to the wireless device over the low capacity channel when the wireless device no longer has access to the high capacity channel.

26. A method as defined in claim 25, wherein the act of the proxy server routing the notification further comprises an act of formatting the notification for transmission over the high capacity channel.

27. A method as defined in claim 25, wherein the act of detecting the high capacity channel further comprises an act of connecting the wireless device with the high capacity network over a communication link.

28. A method as defined in claim 27, wherein the communication link is provided by a network device, the communication link being one of: a serial link, a universal serial bus link, a wireless Bluetooth link, and an infrared link.

29. A method as defined in claim 25, further comprising an act of the proxy server determining that the wireless device no longer has access to the high capacity channel.

30. A method as defined in claim 29, wherein the act of the proxy server determining that the wireless device no longer has access further comprises:
an act of implementing a timeout for the notification sent to the wireless device; and
an act of resuming sending the notification to the wireless device over the low capacity channel if an acknowledgement of the notification is not received by the proxy server before the timeout expires.

31. A computer readable medium having computer executable instructions for performing the acts recited in claim 25.

32. In a system that includes a wireless device and a notification server, wherein the notification server sends notifications to the wireless device over a low capacity channel, a computer program product for implementing a method of routing the notifications over a high capacity channel instead of the low capacity channel when the high capacity channel is available, comprising:
a computer readable medium for carrying machine-executable instructions for implementing the method, wherein the method is comprised of computer-executable instructions for performing acts of:
detecting the high capacity channel by the wireless device, wherein the wireless device has access to the high capacity channel through a network device;
notifying the notification server that the wireless device can receive notifications over the high capacity channel; and
sending notifications over the high capacity channel, wherein the network device forwards the notifications to the wireless device.

33. A computer program product as defined in claim 32, wherein the method further comprises:
an act of detecting that the wireless device no longer has access to the high capacity channel; and
an act of sending notifications over the low capacity channel when the high capacity channel is unavailable to the wireless device.

34. A computer program product as defined in claim 32, wherein the method further comprises:
an act of the wireless device sending an acknowledgement to the notification server for each notification received by the wireless device; and
an act of the notification server determining that the wireless device no longer has access to the high capacity channel if a particular acknowledgement for a particular notification is not received in a time period.

35. A computer program product as defined in claim 32, wherein the method further comprises:
an act of formatting the notification for transmission over the low capacity channel if the high capacity channel is unavailable; and
an act of formatting the notification for transmission over the high capacity channel when the wireless device has access to the high capacity channel.

36. A computer program product as defined in claim 32, wherein the method further comprises an act of docking the wireless device with the network device.
